(19) United States
(12) Patent Application Publication
(10) Pub. No.: US 2023/0192541 A1
(43) Pub. Date: Jun. 22, 2023

(54) FIBER COMPOSITE MATERIAL AND METHOD FOR PRODUCING THE SAME

(71) Applicant: FORMOSA PLASTICS CORPORATION, Kaohsiung City (TW)

(72) Inventors: Wen-Bee KUO, Kaohsiung City (TW); Ming-Hung CHENG, Kaohsiung City (TW); Wan-Tun HUNG, Kaohsiung City (TW); Yu-Cheng CHEN, Kaohsiung City (TW); Wen-Hung TSENG, Kaohsiung City (TW); Kuo-Ming HUANG, Kaohsiung City (TW); Wen-Chieh LAI, Kaohsiung City (TW); Shang-Shih LI, Kaohsiung City (TW); Wen-Yuan CHEN, Kaohsiung City (TW); Hsin TSENG, Kaohsiung City (TW); Hsun-Ku LEE, Tainan City (TW); Yu-Hsin CHEN, Tainan City (TW)

(21) Appl. No.: 18/080,564

(22) Filed: Dec. 13, 2022

(30) Foreign Application Priority Data
Dec. 16, 2021 (TW) 110147154

(51) Int. Cl. C03C 25/40; C03C 25/16; C03C 25/64

(52) U.S. Cl. CPC C03C 25/40; C03C 25/16; C03C 25/64; C03C 2217/47; C03C 2218/111

(57) ABSTRACT

The present invention relates to a fiber composite material and a method for producing the fiber composite material. The method for producing the fiber composite material includes a hydrolysis step of a silicon precursor having an alkoxy group, an in-situ condensation step and a drying step. A specific silicon precursor having a secondary amino group and alkyl groups is used therein, as well as a specific weight ratio of the silicon precursor to a fiber material, the in-situ condensation step can be performed in the absence of organic solvents in the method for producing the fiber composite material, and a hydrophobic modification on silicon-based gels can be performed, thereby simplifying the process, decreasing a thermal conductivity of the resulted fiber composite material and preventing drop dust of the resulted fiber composite material.

### RELATED APPLICATION

This application claims priority to Taiwan Application Serial Number 110147154, filed on Dec. 16, 2021, which is herein incorporated by reference in its entirety.

### BACKGROUND

### Field of Invention

The present invention relates to a fiber composite material and a method for producing the same, and more particularly relates to the method for producing the fiber composite material in the absence of organic solvents and the resulted fiber composite material.

### Description of Related Art

Conventionally, in methods for producing a fiber composite material, silicon-based powders are prepared in solvents to produce a dispersed solution. The dispersed solution is coated on a fiber material by dipping or injecting methods, and then dried under a normal pressure, so as to produce the fiber composite material. The fiber composite material includes the fiber material and the silicon-based powders coated thereon. The fiber material includes a heat-insulating fiber material such as glass fibers and ceramic fibers. The silicon-based powders are a material with a porous network structure, which has a high porosity, a high specific surface area, a small pore diameter, and pores filled with gas (e.g. air), leading in the silicon-based powders with a low thermal conductivity. Therefore, the resulted fiber composite material can be used as a heat-insulating material.

However, it is hardly to prepare the silicon-based powders in a stably dispersed solution or coating uniformity thereof is poor, and thus the adherence between the silicon-based powders and the fiber material is reduced. Moreover, the silicon-based powders reduce their porosity due to their cracking flakiness structure, further increase the thermal conductivity of the resulted fiber composite material and worsen drop dust thereof.

In view of these, it is necessary to develop a composite material and a method for producing the composite material to improve the aforementioned drawbacks of the conventional composite material and the method for producing the same.

### SUMMARY

Accordingly, an aspect of the present invention is to provide a method for producing a fiber composite material. In the method for producing the fiber composite material, a specific silicon precursor having a secondary amino group and alkyl groups is used, as well as a specific weight ratio of the silicon precursor to a fiber material, an in-situ condensation step is performed in the absence of organic solvents, and a hydrophobic modification on silicon-based gels is performed, thereby simplifying process and decreasing a thermal conductivity of the resulted fiber composite material.

Another aspect of the present invention is to provide a fiber composite material. The fiber composite material is produced by the aforementioned method for producing the fiber composite material.

According to an aspect of the present invention, a method for producing a fiber composite material is provided. In the method, a hydrolysis step is performed on a first silicon precursor, an emulsifying agent and water, so as to obtain a hydrolyzed solution. Next, a treating step is performed on a fiber material, so as to spread the hydrolyzed solution on the fiber material. Then, an in-situ condensation step is performed on the fiber material and a second silicon precursor after the treating step is finished, so as to obtain a wet colloid composite material. Afterwards, a drying step is performed on the wet colloid composite material, so as to obtain the fiber composite material. All of the hydrolysis step, the treating step and the in-situ condensation step exclude organic solvents.

According to one embodiment of the present invention, the first silicon precursor comprises a silicate compound and/or a silane compound. The silicate compound comprises alkali metal silicates and/or alkali metal ammonium silicates. The silane compound comprises a methyl silicone compound, and the methyl silicone compound is one or more compounds selected from the group consisting of methyltrimethoxysilane, methyltriethoxysilane, dimethyldimethoxysilane, and dimethyldiethoxysilane.

According to another embodiment of the present invention, based on a weight of the first silicon precursor as 100 parts by weight, a weight of the emulsifying agent is 0.1 to 1 part by weight.

According to yet another embodiment of the present invention, the hydrolysis step is performed at a pH of 2.5 to 4.0.

According to yet another embodiment of the present invention, the second silicon precursor comprises one or more compounds with a structure shown by the following formula (I):

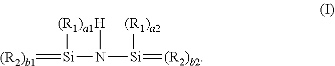

In the formula (I), each R₁ is independently hydrogen atom or alkyl having 1 to 4 carbon atoms, R₂ is alkylene having 1 to 4 carbon atoms, and b1 and b2 each are independently zero or 1; when both of the b1 and the b2 is zero, both of the a1 and the a2 is 3; when both of the b1 and the b2 is 1, both of the a1 and the a2 is 1.

According to yet another embodiment of the present invention, the second silicon precursor is one or more compounds selected from the group consisting of tetraalkyl disilazane and hexaalkyl disilazane.

According to yet another embodiment of the present invention, a weight ratio of the first silicon precursor to the fiber material is 0.20 to 2.00.

According to yet another embodiment of the present invention, a weight ratio of the second silicon precursor to the fiber material is 0.05 to 0.75.

According to another aspect of the present invention, a fiber composite material is provided. The fiber composite material is produced by the aforementioned method for producing the fiber composite material, in which a thermal conductivity coefficient of the fiber composite material is less than 0.035 W/m·K.

According to one embodiment of present invention, based on an amount of the fiber composite material as 100 weight percent, a loading capacity of silicon-based powders is not greater than 70 weight percent.

According to another aspect of the present invention, a method for producing a fiber composite material is provided. In the method, a hydrolysis step is performed on a first silicon precursor, an emulsifying agent and water, so as to obtain a hydrolyzed solution. Next, a treating step is performed on a fiber material, so as to spread the hydrolyzed solution on the fiber material. Then, an in-situ condensation step is performed on the fiber material and a second silicon precursor after the treating step is finished, so as to obtain a wet colloid composite material. A weight ratio of the first silicon precursor to the second silicon precursor is 1:0.10 to 1:0.45. Afterwards, a drying step is performed on the wet colloid composite material, so as to obtain the fiber composite material. All of the hydrolysis step, the treating step and the in-situ condensation step exclude organic solvents.

According to yet aspect of the present invention, a fiber composite material is provided. The fiber composite material comprises a fiber material and silicon-based powders coated on the fiber material. Based on an amount of the fiber composite material as 100 weight percent, an amount of the silicon-based powders is not greater than 70 weight percent.

In an application of the fiber composite material and the method for producing the fiber composite material of the present invention, in which the specific silicon precursor having the secondary amino group and the alkyl groups is used, as well as the specific weight ratio of the silicon precursor to the fiber material. In the method for producing the fiber composite material, the in-situ condensation step can be performed in the absence of organic solvents, and the hydrophobic modification on the silicon-based gels can be performed, so as to simplify process and decrease the thermal conductivity of the resulted fiber composite material.

### BRIEF DESCRIPTION OF THE DRAWINGS

Now please refer to description below and accompany with corresponding drawings to more fully understand embodiemnts of the present invention and advantages thereof. It has to be emphasized that all kinds of characteristics are not drawn in scale and olny for illustrative purpose. The description regarding to the drawings as follows:

FIG. 1 illustrates a flow chart of a method for producing a fiber composite material according to an embodiment of the present invention.

FIGS. 2A to 2C are electron micrographs of fiber composite materials according to embodiments 1 to 3 of the present invention, respectively.

FIGS. 2D to 2E are electron micrographs of fiber composite materials according to comparative embodiments 1 to 2 of the present invention, respectively.

### DETAILED DESCRIPTION

A manufacturing and usage of embodiments of the present invention are discussed in detail below. However, it could be understood that embodiments provide much applicable invention conception which can be implemented in various kinds specific contents. The specific embodiments discussed are only for illustration, but not be a limitation of scope of the present invention.

In a method for producing a fiber composite material of the present invention, a hydrolyzed solution containing monomers of silicon-based powders is first coated on a fiber material to obtain a coated fiber material, in which the hydrolyzed solution contains the aftermentioned first silanol compound, and then an in-situ condensation step is performed on the first silanol compound in the coated fiber material by using a silicon precursor (i.e. the aftermentioned second silicon precursor) having a secondary amino group and alkyl groups.

In detail, an acid catalyst in the hydrolyzed solution can facilitate the second silicon precursor hydrolyze to generate ammonia water and a silanol compound with several alkyl group (i.e. the aftermentioned second silanol compound). The ammonia water catalyzes the in-situ condensation of the first silanol compound. The aforementioned ammonia water is generated continuously in small amounts, such that the first silanol compound directly undergoes the in-situ condensation on the fiber material, so as to produce polysiloxane particles with small and uniform sizes, which are uniformly distributed on the fiber material, and thus an adherence between the particles and the fiber material is enhanced.

Further, these particles can aggregate (or stack) to form silicon-based gels with a three-dimensional network structure. The aforementioned second silanol compound undergoes a hydrophobic modification on the silicon-based gels to facilitate the subsequent removal of moisture inside the pores in the structure of the silicon-based gels, and thus the integrity of the structure can be retained after dried, so as to produce the silicon-based powders with a three-dimensional network structure having a good denseness and a high porosity, thereby preventing drop dust of the resulted fiber composite material and decreasing a thermal conductivity coefficient thereof.

In another method for producing a fiber composite material of the present invention, a hydrolysis step is performed on a first silicon precursor, an emulsifying agent and water, so as to obtain a hydrolyzed solution. Next, a treating step is performed on a fiber material, so as to spread the hydrolyzed solution on the fiber material. Then, an in-situ condensation step is performed on the fiber material and a second silicon precursor after the treating step is finished, so as to obtain a wet colloid composite material. A weight ratio of the first silicon precursor to the second silicon precursor is 1:0.10 to 1:0.45. Afterwards, a drying step is performed on the wet colloid composite material, so as to obtain the fiber composite material. All of the hydrolysis step, the treating step and the in-situ condensation step exclude organic solvents.

The fiber composite material comprises a fiber material and silicon-based powders coated on the fiber material. Based on an amount of the fiber composite material as 100 weight percent, an amount of the silicon-based powders is not greater than 70 weight percent.

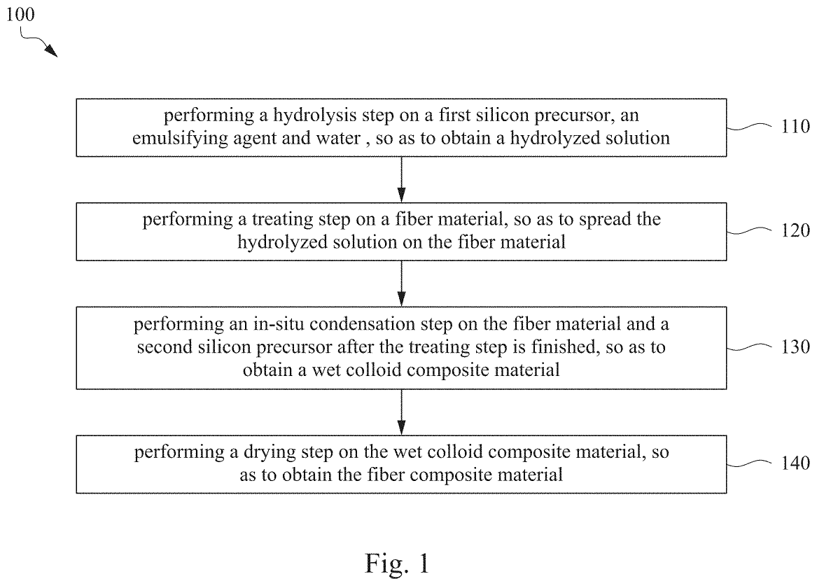

Referring to FIG. 1, in the method 100 for producing the fiber composite material, a hydrolysis step is first performed on a first silicon precursor, an emulsifying agent and water, so as to obtain a hydrolyzed solution, as shown in an operation 110. In some embodiments, the first silicon precursor can comprise a silicate compound and a silane compound and a mixture thereof. In some specific examples, the silicate compound can comprise alkali metal silicates and/or alkali metal ammonium silicates, such as potassium silicate, sodium silicate, lithium silicate and ammonium silicate. When the first silicon precursor comprises the aforementioned silicate compound, the silicate compound facilitates polysiloxane particles aggregate (or stack) to form silicon-based gels with a three-dimensional network structure, and thus a thermal conductivity coefficient of the fiber composite material is decreased, and the drop dust thereof is prevented.

Specific examples of the silane compound can include, but are not limited to, methyl siloxane compound. Preferably, the methyl siloxane compound is one or more compounds selected from the group consisting of methyltrimethoxysilane, methyltriethoxysilane, dimethyldimethoxysilane, and dimethyldiethoxysilane. When the first silicon precursor comprises the aforementioned silane compounds, a silanol compound generated by the hydrolysis step has three silanol groups and one lower alkyl group, and thus it is beneficial to produce the silicon-based powders having a dense three-dimensional network structure, thereby decreasing the thermal conductivity of the resulted fiber composite material and preventing the drop dust thereof.

In some embodiments, the emulsifying agent can include, but is not limited to, cetyltrimethylammonium bromide (CTAB), dodecyl trimethyl ammonium bromide (DTAB), and cetyltrimethylammonium chloride (CTAC). In some specific examples, based on a weight of the first silicon precursor as 100 parts by weight, a weight of the emulsifying agent is 0.1 to 1 part by weight. When the weight of the emulsifying agent is in the aforementioned range, the emulsifying agent is enough to emulate the first silicon precursor, such that a first silicon precursor solution is easily prepared, thereby facilitating the subsequent hydrolysis step.

In the hydrolysis step, the silicate compound of the first silicon precursor is hydrolyzed into a silicic acid and alkali metal ions or ammonium ions, and the silane compound of the first silicon precursor is hydrolyzed into a silanol compound and lower alcohols. Carbon numbers of the lower alcohols are dependent on structures of the silane compound of the first silicon precursor.

In some embodiments, the hydrolysis step is performed at a pH of 2.5 to 4.0, and preferably 3.5 to 3.8. The pH of the hydrolysis step is controlled by adding an acid catalyst to the first silicon precursor solution. The acid catalyst can include, but is not limited to, inorganic acids and lower organic acids. Specific examples of the inorganic acids can include hydrochloric acid and phosphoric acid, and specific examples of the lower acids can include formic acid, acetic acid and oxalic acid. When the hydrolysis step is performed at the pH of 2.5 to 4.0, it is beneficial to hydrolyze the first silicon precursor, and to prevent products generated by the hydrolysis of the first silicon precursor from undergoing a condensation, so as to prevent the first silicon precursor from being hydrolyzed incompletely. Therefore, it is beneficial to produce the silicon-based powders with the three-dimensional network structure, thereby decreasing the thermal conductivity of the resulted fiber composite material and preventing the drop dust thereof.

After the operation 110, a treating step is performed on a fiber material, so as to spread the hydrolyzed solution on the fiber material, as shown in an operation 120. In some embodiments, the fiber material can include glass fibers and ceramic fibers, and specific examples can be fiberglass blankets and fiberglass mats. When the fiber material is glass fiber material, the thermal conductivity of the resulted fiber composite material can be decreased. Besides, the treating step can be performed by approaches, such as dipping, coating, injecting and spraying. In some specific examples, based on an amount of the fiber material as 100 weight percent, a loading capacity of the first silicon precursor is 15 weight percent to 60 weight percent. When the loading capacity of the first silicon precursor is in the aforementioned range, the first silicon precursor is enough to be totally and uniformly distributed on surfaces of the fibers of the fiber material, and thus the thermal conductivity of the resulted fiber composite material is decreased.

After the operation 120, an in-situ condensation step is performed on the fiber material and a second silicon precursor after the treating step is finished, so as to obtain a wet colloid composite material, as shown in an operation 130. In the in-situ condensation step, the second silicon precursor is first applied to the aforementioned fiber material. There are no specific limitations to approaches for applying the second silicon precursor to the fiber material and approaches for spreading the hydrolyzed solution on the fiber material, but it should be achieved the purpose of the aforementioned weight ratio (i.e. 0.20 to 2.00) of the first silicon precursor to the fiber material and the aforementioned weight ratio (i.e. 0.05 to 0.75) of the second silicon precursor to the fiber material. For example, the second silicon precursor can be applied to the fiber material by approaches, such as dipping, coating, injecting and spraying.

In some specific examples, the second silicon precursor can be applied to the coated fiber material by means of an aqueous solution. Since heating may result in a decomposition or an oxidation of the second silicon precursor, the second silicon precursor is dissolved in water, and is not heated into a gaseous silicon precursor. In the method 100 for producing the fiber composite material, all of the hydrolysis step 110, the treating step 120 and the in-situ condensation step 130 exclude organic solvents.

In some embodiments, the second silicon precursor can comprise one or more compounds with a structure shown as the following formula (I):

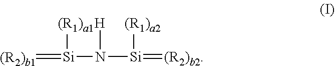

In the formula (I), each R₁ is independently hydrogen atom or alkyl having 1 to 4 carbon atoms, R₂ is alkylene having 1 to 4 carbon atoms, and b1 and b2 each is independently zero or 1; when both of the b1 and the b2 is zero, both of the a1 and the a2 is 3; when both of the b1 and the b2 is 1, both of the a1 and the a2 is 1.

The second silicon precursor has a secondary amino group and several alkyl groups, and can be hydrolyzed into ammonia water and a silanol compound (also referred to as the second silanol compound). Because the aforementioned ammonia water is generated continuously in small amounts, such that the first silanol compound generated by the hydrolysis of the first silicon precursor directly undergoes the in-situ condensation on the fiber material, so as to produce polysiloxane particles with a small and uniform size, and the polysiloxane particles are uniformly distributed on the fiber material, thereby enhancing an adherence between the particles and the fiber material. Therefore, these particles can aggregate (or stack) to form the silicon-based gels with a three-dimensional network structure by the ammonia water used as a basic catalyst of the in-situ condensation.

On the other hand, the second silanol compound can hydrophobically modify the surfaces of the silicon-based gels. In detail, one silanol group of the second silanol compound can react with a silanol group on the surfaces of the silicon-based gels to generate one siloxy group, and several hydrophobic alkyl groups of the silanol compounds can enhance a hydrophobicity of the surfaces of the silicon-based gels. The enhanced hydrophobicity can facilitate the removal of moisture inside pores in the structure of the silicon-based gels, and thus the silicon-based powders with the three-dimensional network structure having the good denseness and the high porosity can be produced, thereby preventing the drop dust of the resulted fiber composite material and decreasing thermal conductivity coefficient thereof.

However, in conventional methods for producing the fiber composite material, the silicon-based powders are fist prepared. Then, after the silicon-based powders are prepared as a dispersed solution, the dispersed solution is coated on the fiber material. Therefore, it is necessary to use organic solvents to dissolve the silicon-based powders in the conventional methods for producing the fiber composite material. Moreover, in order to increase the adherence between the silicon-based powders and the fibers of the fiber material, a binder can be used in the conventional methods for producing the fiber composite material, for preventing the drop dust of the fiber composite material. On the contrary, in the method 100 for producing the fiber composite material of the present invention, by using the in-situ condensation step, the drop dust of the fiber composite material can be prevented in the absence of the organic solvents and the binder, and therefore the process is simplified, and a safety of the process is enhanced.

In some embodiments, in the formula (I), when both of the b1 and the b2 is zero and both of the a1 and the a2 is 3, the number of the hydrophobic alkyl group is more, such that the hydrophobicity of the silicon-based gels can further be enhanced. In other embodiments, when both of the b1 and the b2 is 1 and both of the a1 and the a2 is 1, silicon-carbon double bond can provide a site for reaction, so as to facilitate production of the silicon-based powders with the three-dimensional network structure and enhance the adherence between the silicon-based powders and the fiber material, thereby preventing the drop dust of the resulted fiber composite material.

In some preferable examples, the second silicon precursor is one or more compounds selected from the group consisting of tetraalkyl disilazane and hexaalkyl disilazane. Specific examples of the hexaalkyl disilazane can include hexamethyl disilazane (HMDS). When the aforementioned second silicon precursor is used, because the second silicon precursor has more hydrophobic alkyl group, the hydrophobicity of the silicon-based gels is further enhanced, thereby facilitating the removal of moisture inside the pores in the structure of the silicon-based gels. Therefore, the integrity of the structure can be retained after dried, so as to produce the silicon-based powders with the three-dimensional network structure, thereby preventing the drop dust of the fiber composite material and decreasing thermal conductivity coefficient thereof.

In some embodiments, a weight ratio of the first silicon precursor to the second silicon precursor is 1:0.075 to 1:0.50, preferably 1:0.10 to 1:0.45, and more preferably 1:0.15 to 1:0.375. When the weight ratio of the first silicon precursor to the second silicon precursor is in the aforementioned range, the second silicon precursor can be hydrolyzed into sufficient silanol compound and sufficient the ammonia water, so as to enhance the adherence between the silicon-based powders and the fiber material, and to facilitate production of the silicon-based powders with the three-dimensional network structure, thereby preventing the drop dust of the resulted fiber composite material and decreasing the thermal conductivity coefficient thereof.

In some embodiments, a weight ratio of the second silicon precursor to the fiber material is 0.05 to 0.75, and preferably 0.2 to 0.5. When the weight ratio of the second silicon precursor to the fiber material is in the aforementioned range, the second silicon precursor can produce sufficient ammonia water, so as to facilitate the first silanol compound to undergo the in-situ condensation, and thus the adherence between the silicon-based powders and the fiber material is enhanced, thereby preventing the drop dust of the fiber composite material.

After the operation 130, a drying step is performed on the wet colloid composite material, so as to obtain the fiber composite material, as shown in an operation 140. The drying step is used to remove solvents used before the drying step, and the solvents include the moisture inside the pores in the three-dimensional network structure of the silicon-based gels, so as to obtain dried fiber composite material. In some embodiments, the drying step can be performed at a normal pressure and a temperature of 70° C. to 150° C. In some specific examples, the drying step can be performed by using drying devices, such as an oven, a microwave oven and a fluid bed.

Another aspect of the present invention is to provide a fiber composite material, which is produced by the aforementioned method for producing the fiber composite material. A thermal conductivity coefficient of the fiber composite material is less than 0.035 W/m·K. If the thermal conductivity coefficient of the fiber composite material is not in the aforementioned range, the fiber composite material cannot be used as thermal insulation material. Preferably, the thermal conductivity coefficient of the fiber composite material can be 0.01 W/m·K to 0.033 W/m·K. Specific application examples of the aforementioned thermal insulation material can include, but are not limited to, water-proof and thermal insulation blankets, hydrophobic fire-proof blankets and fire-fighting blankets.

In some embodiments, based on the amount of the fiber composite material as 100 weight percent, a loading capacity of the silicon-based powders is not greater than 70 weight percent. When the loading capacity of the silicon-based powders is in the aforementioned range, the thermal conductivity coefficient of a composite blanket made by the silicon-based powders can be decreased.

The following embodiments are used to illustrate the applications of the present invention, but they are not used to limit the present invention, it could be made various changes or modifications for a person having ordinary sill in the art without apart from the inspire and scope of the present invention.

Production of fiber composite material

### Embodiment 1

In the embodiment 1, a hydrolysis step was performed by using 0.1% hydrochloric acid, 100 parts by weight of methyltrimethoxysilane, 0.5 parts by weight of cetyltrimethylammonium bromide, and 114 parts by weight of water, and a pH was controlled at 2.5 to 4.0, so as to obtain a hydrolyzed solution. Then, a fiber material (i.e. a fiberglass blanket) was dipped in the hydrolyzed solution for 1 to 2 minutes, taken out and drained vertically for 3 minutes, and then left to stand horizontally for 5 minutes, so as to obtain the coated fiber material. Next, a hexamethyl disilazane aqueous solution was uniformly dropped into the coated fiber material, so as to obtain a wet colloid composite material, in which a weight ratio of the hexamethyl disilazane to the fiber material was 0.2. Next, drying by using a microwave oven was performed at 100° C. to dry the wet colloid composite material, and thereby obtaining the fiber composite material of the embodiment 1.

### Embodiments 2 to 3 and Comparative Embodiments 1 to 7

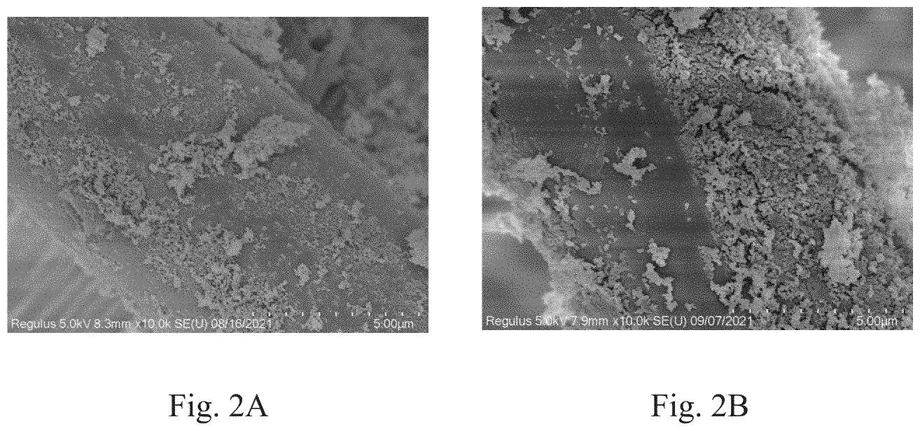

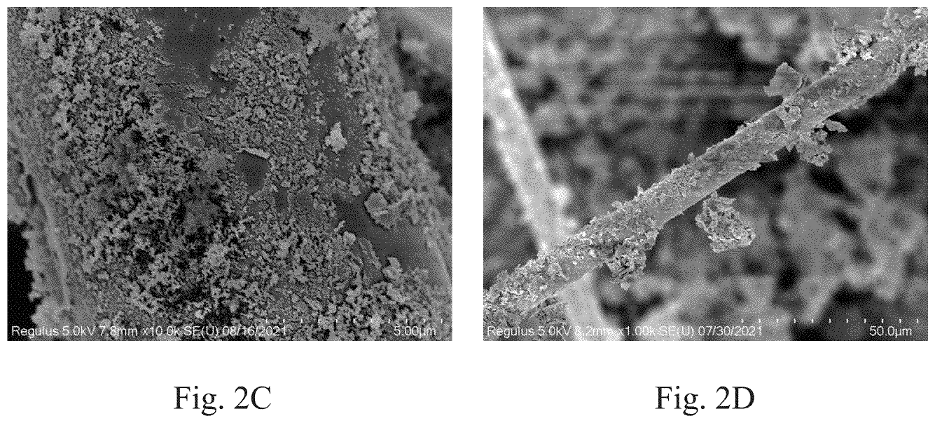

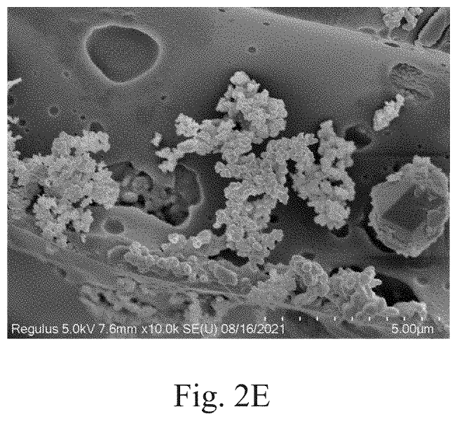

The embodiments 2 to 3 and the comparative embodiments 1 to 7 were practiced with the same method as in the embodiment 1 by using various weight ratio of the first silicon precursor to the fiber material and various weight ratio of the second silicon precursor to the fiber material. However, in the comparative embodiment 1, the second silicon precursor was not used. In the comparative embodiments 2 to 7, commercial silicon-based powders were dispersed by the dispersed solution to obtain the dispersed solution containing the silicon-based powders, in which an amount of the silicon-based powders was based on an amount of the dispersed solution as 100 weight percent, and a viscosity of the dispersed solution containing the silicon-based powders was 800 cps to 1000 cps. A fiberglass blanket was dipped in the dispersed solution containing the silicon-based powders for 1 to 2 minutes, taken out and tightly pressed until a thickness of the fiberglass blanket became to 10 mm. Then, at a normal pressure and a temperature of 110° C., the fiberglass blanket was dried for 2 hours to obtain fiber composite material of each of the comparative embodiments 2 to 7. Specific formulations and evaluated results of embodiments 1 to 3 and comparative embodiments 1 to 7 were shown in Table 1, Table 2 and FIGS. 2A to 2E, in which FIGS. 2A to 2E were electron micrographs of the fiber composite materials of embodiments 1 to 3 and the comparative embodiments 1 to 2, respectively.

Evaluation Methods

1. Evaluation of Loading Capacity of Silicon-Based Powders

The loading capacity of the silicon-based powders into the fiber material was calculated based on the amount of the fiber material as 100 weight percent in which a weight difference between the fiber composite material and the fiber material was measured, and the weight difference was resulted from the silicon-based powders, and then the loading capacity of the silicon-based powders was calculated.

2. Evaluation of Thermal Conductivity Coefficient of Fiber Composite Material

The thermal conductivity coefficient of the fiber composite material was measured by a thermal conductivity analyzer accordingly to ASTM C518. The measured thermal conductivity coefficient of the fiber composite material was used to evaluate a heat-insulating property of the fiber composite material. When the thermal conductivity coefficient of the fiber composite material is less than 0.035 W/m K, the fiber composite material has a good heat-insulating property.

3. Evaluation of Drop Dust of Fiber Composite Material

The fiber composite material was put into a packing bag, applied with a force of 5 to 10 Newtons, and shaken up and down in a height of 3 to 5 cm. Then, an amount of the drop dust of the fiber composite material was observed and evaluated by the following criteria:
◯: no drop dust,
Δ: less drop dust,
×: heavy drop dust.

4. Evaluation of Powder Morphology of Silicon-Based Powders

The morphology of the silicon-based powders on the fiber composite material was observed by a scanning electron microscopy to evaluate a microstructure of the silicon-based powders, in which operation parameters used herein were commonly known by one person having ordinary skill in the art.

TABLE 1

| | | | | | | Comparative |
|---|---|---|---|---|---|---|
| | | | Embodiment | | | embodiment |
| | | | 1 | 2 | 3 | 1 |
| Process | Hydrolysis | first silicon | methyltrimethoxysilane | | | methyltrimethoxysilane |
| | step | precursor | | | | |
| | Condensation | second silicon | Hexa methyl disilazane | | | none |
| | step | precursor | | | | |
| | | weight ratio of | 1.2 | 0.4 | 1.0 | none |
| | | first silicon | | | | |
| | | precursor to | | | | |
| | | fiber material | | | | |
| | | weight ratio of | 0.2 | 0.2 | 0.1 | none |
| | | second silicon | | | | |
| | | precursor to | | | | |
| | | fiber material | | | | |
| | | approach of | in-situ | in-situ | in-situ | in-situ |
| | | condensation | | | | |
| Evaluated | Fiber | loading | 37.5 | 19.4 | 36.12 | 36.82 |
| result | composite | capacity of | | | | |
| | material | silicon-based | | | | |
| | | powders (weight | | | | |
| | | percent) | | | | |
| | | thermal | 0.0339 | 0.0325 | 0.0343 | 0.0371 |
| | | conductivity | | | | |
| | | coefficient | | | | |
| | | (W/m · K) | | | | |
| | | drop dust | ◯ | ◯ | ◯ | X |
| | | powder | dense, 3D | dense, 3D | dense, 3D | big grain |
| | | morphology | network | network | network | |
| | | | structure | structure | structure | |

TABLE 2

| | | | Comparative embodiment | | | | | |
|---|---|---|---|---|---|---|---|---|
| | | | 2 | 3 | 4 | 5 | 6 | 7 |
| Process | Dispersed | type | water | water | water | water | ethanol | ethanol |
| | solvent | amount(weight | 20 | 20 | 20 | 20 | 20 | 7 |
| | | percent) | | | | | | |
| Evaluated | Fiber | loading | 41 | 53 | 69 | 35 | 61 | poor |
| result | composite | capacity of | | | | | | dispersibility, |
| | material | silicon-based | | | | | | dipping step |
| | | powders (weight | | | | | | can not be |
| | | percent) | | | | | | performed |
| | | thermal | 0.0408 | 0.0374 | 0.0365 | 0.0368 | 0.0437 | |
| | | conductivity | | | | | | |
| | | coefficient | | | | | | |
| | | (W/m · K) | | | | | | |
| | | drop dust | Δ | Δ | X | ◯ | X | |

Referring to Table 1 and FIGS. 2A, 2B, 2C and 2D, in comparison with the comparative embodiment 1, the second silicon precursor was used in the embodiments 1 to 3, and the weight ratio of the second silicon precursor to the fiber material was in a range of 0.05 to 0.75. The composite blanket made by the silicon-based powders in the aforementioned weight ratio could have the three-dimensional network structure, and thus the thermal conductivity coefficient of the composite blanket made by the silicon-based powders was decreased.

Referring to Table 1, Table 2, FIGS. 2A to 2C, and FIG. 2E, in comparison with the comparative embodiments 2 to 7, the in-situ condensation step was performed in the embodiments 1 to 3. The in-situ condensation step could produce the silicon-based powders directly formed on the glass fibers of the fiberglass blanket, and therefore the silicon-based powders were uniformly distributed on the glass fibers, and formed the three-dimensional network structure, thereby enhancing the adherence between the silicon-based powders and the fibers. The enhanced adherence prevented the composite blanket made by the silicon-based powders from drop dust, and the three-dimensional network structure of the silicon-based powders decreased the thermal conductivity coefficient of the composite blanket made by the silicon-based powders. Besides, the in-situ condensation could omit the preparation of the dispersed solution, and thus the process was simplified.

In summary, in an application of the method for producing the fiber composite material of the present invention, a silicon precursor having a secondary amino group and alkyl groups is used therein, as well as a specific weight ratio of the silicon precursor to a fiber material, the in-situ condensation step can be performed in the absence of organic solvents in this method, so as to produce the silicon-based powders with the three-dimensional structure. Therefore, the thermal conductivity coefficient of the resulted fiber composite material is decreased, and the drop dust thereof is prevented.

Although the present invention has been disclosed in several embodiments as above mentioned, these embodiments do not intend to limit the present invention. Various changes and modifications can be made by those of ordinary skills in the art of the present invention, without departing from the spirit and scope of the present invention. Therefore, the claimed scope of the present invention shall be defined by the appended claims.

What is claimed is:

1. A method for producing a fiber composite material, comprising:
performing a hydrolysis step on a first silicon precursor, an emulsifying agent and water, so as to obtain a hydrolyzed solution;
performing a treating step on a fiber material, so as to spread the hydrolyzed solution on the fiber material;
performing an in-situ condensation step on the fiber material and a second silicon precursor after the treating step is finished, so as to obtain a wet colloid composite material; and
performing a drying step on the wet colloid composite material, so as to obtain the fiber composite material,
wherein all of the hydrolysis step, the treating step and the in-situ condensation step exclude organic solvents.

2. The method for producing the fiber composite material of claim 1, wherein the first silicon precursor comprises:
a silicate compound, wherein the silicate compound comprises alkali metal silicates and/or alkali metal ammonium silicates; and/or
a silane compound, wherein the silane compound comprises a methyl siloxane compound, and the methyl siloxane compound is one or more compounds selected from the group consisting of methyltrimethoxysilane, methyltriethoxysilane, dimethyldimethoxysilane, and dimethyldiethoxysilane.

3. The method for producing the fiber composite material of claim 1, wherein based on a weight of the first silicon precursor as 100 parts by weight, a weight of the emulsifying agent is 0.1 to 1 part by weight.

4. The method for producing the fiber composite material of claim 1, wherein the hydrolysis step is performed at a pH of 2.5 to 4.0.

5. The method for producing the fiber composite material of claim 1, wherein based on an amount of the fiber material as 100 weight percent, a loading capacity of the first silicon precursor is 15 weight percent to 60 weight percent.

6. The method for producing the fiber composite material of claim 1, wherein the second silicon precursor is dissolved in water.

7. The method for producing the fiber composite material of claim 1, wherein the second silicon precursor comprises one or more compounds with a structure shown by the following formula (I): 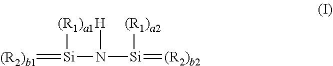
in the formula (I), each R₁ is independently hydrogen atom or alkyl having 1 to 4 carbon atoms, R₂ is alkylene having 1 to 4 carbon atoms, and b1 and b2 each are independently zero or 1; when both of the b1 and the b2 is zero, both of the a1 and the a2 is 3; when both of the b1 and the b2 is 1, both of the a1 and the a2 is 1.

8. The method for producing the fiber composite material of claim 7, wherein both of the b1 and the b2 is zero, and both of the a1 and the a2 is 3.

9. The method for producing the fiber composite material of claim 7, wherein both of the b1 and the b2 is 1, and both of the a1 and the a2 is 1.

10. The method for producing the fiber composite material of claim 7, wherein the second silicon precursor is one or more compounds selected from the group consisting of tetraalkyl disilazane and hexaalkyl disilazane.

11. The method for producing the fiber composite material of claim 1, wherein a weight ratio of the first silicon precursor to the fiber material is 0.20 to 2.00.

12. The method for producing the fiber composite material of claim 1, wherein a weight ratio of the second silicon precursor to the fiber material is 0.05 to 0.75.

13. The method for producing the fiber composite material of claim 1, wherein a weight ratio of the first silicon precursor to the second silicon precursor is 1:0.075 to 1:0.50.

14. A method for producing a fiber composite material, comprising:
performing a hydrolysis step on a first silicon precursor, an emulsifying agent and water, so as to obtain a hydrolyzed solution;
performing a treating step on a fiber material, so as to spread the hydrolyzed solution on the fiber material;
performing an in-situ condensation step on the fiber material and a second silicon precursor after the treating step is finished, so as to obtain a wet colloid composite material, wherein a weight ratio of the first silicon precursor to the second silicon precursor is 1:0.10 to 1:0.45; and
performing a drying step on the wet colloid composite material, so as to obtain the fiber composite material,
wherein all of the hydrolysis step, the treating step and the in-situ condensation step exclude organic solvents.

15. The method for producing the fiber composite material of claim 14, wherein the hydrolysis step is performed at a pH of 3.5 to 3.8.

16. The method for producing the fiber composite material of claim 14, wherein a weight ratio of the second silicon precursor to the fiber material is 0.2 to 0.5.

17. The method for producing the fiber composite material of claim 14, wherein a weight ratio of the first silicon precursor to the second silicon precursor is 1:0.15 to 1:0.375.

18. A fiber composite material, comprising:
a fiber material; and
silicon-based powders coated on the fiber material,
wherein based on an amount of the fiber composite material as 100 weight percent, an amount of the silicon-based powders is not greater than 70 weight percent.

19. The fiber composite material of claim 18, wherein a thermal conductivity coefficient of the fiber composite material is less than 0.035 W/m·K.

20. The fiber composite material of claim 19, wherein the thermal conductivity coefficient is 0.01 W/m·K to 0.033 W/m K.
